(19) United States
(12) Patent Application Publication
(10) Pub. No.: US 2006/0032643 A1
(43) Pub. Date: Feb. 16, 2006

(54) Jet blast firefighting system

(76) Inventor: Paul Dwight Thompson, Walnut Grove, CA (US)

Correspondence Address: SIERRA PATENT GROUP, LTD., 1657 Hwy 395, Suite 202, Minden, NV, 89423, US

(21) Appl. No.: 11/201,738

(22) Filed: Aug. 10, 2005

Related U.S. Application Data
(60) Provisional application No. 60/601,658, filed on Aug. 12, 2004.

(51) Int. Cl. A62C 3/00

(52) U.S. Cl. 169/54; 169/67

(57) ABSTRACT

A jet-engine based multiple firefighting system comprising: a platform; a frame pivotally mounted on the platform at a pivot point; a jet engine mounted on the frame; a tailpipe extending from an exhaust end of the jet engine; an outer discharge pipe slideably mounted on the frame and disposed around the tailpipe to define an annular space, the outer discharge pipe having an intake end into which the tailpipe extends; and a liquid injection system mounted on the outer discharge pipe around the tailpipe and configured to inject firefighting liquid into the annular space.

### CROSS-REFERENCE TO RELATED APPLICATIONS

This application claims priority to U.S. Provisional Application Ser. No. 60/601,658, filed Aug. 12, 2004, which is hereby incorporated by reference as if set forth herein.

### BACKGROUND OF THE INVENTION

Wild fires such as forest fires and brush fires result in extensive damage to natural resources as well as destruction to property. The cost of fighting such fires is substantial. Techniques including aerial tankers, helicopters equipped with water tanks and tethered buckets, and ground crews are currently employed to fight such fires.

### BRIEF DESCRIPTION OF THE INVENTION

A jet-engine based multiple firefighting system is disclosed. A jet engine having a thrust of about 1,000 lbs. or more is mounted on a frame. The frame is both pivotally and rotatably mounted on a platform. The platform may be mounted on a truck, trailer, other track or 6×6 carrier to be mobile.

A tailpipe is fitted to the exhaust end of the jet engine and may be formed from a material such as stainless steel. An outer discharge pipe is disposed around the tailpipe and may have a flared intake end into which the tailpipe extends. The outer discharge pipe may be generally cylindrical in shape and is translatable along an axis defined by the tailpipe.

An injection ring is mounted on the outer discharge pipe around the tailpipe and has a plurality of inward facing apertures through which water or other firefighting liquid may be injected into the space between the tailpipe and the outer discharge pipe. A water, gel, or soap nozzle may be mounted at the exhaust end of the discharge pipe.

The jet blast travels through the tailpipe and into the outer discharge pipe. The space between the intake end of the outer discharge pipe and the tailpipe acts as a venturi that may be varied by translating the outer discharge pipe along its axis to vary the amount of air pulled in through the intake end. Pressurized water may be fed to the injection ring and into the venturi, where it is atomized and travels along the fast flow of heated jet exhaust. The amount of water injected into the discharge pipe may be varied from zero to about 500 gallons per minute, if needed, at pressures from between about zero to about 300 psi. With the jet engine running at about 70% power and water flow set at about 30 to about 50 gallons per minute at a pressure of about 150 psi, the discharge is like a heavy fog. If the water flow rate and pressure is increased, the system acts as a fine spray nozzle. If a foam concentrate is added to the water, the discharge becomes a fire-retardant foam that can totally engulf an average house and grounds within about one minute.

By pumping a fire-retardant mixture through the nozzle at the exhaust end of the discharge pipe, the fire retardant mixture can be spread over a large area in seconds as the unit moves along at a slow speed. At full jet-engine power, the system can cover about two acres in a minute. The soap concentrate can be added into the water by means of an injection pump. The water pressure may be established and maintained by use of a high-pressure fire pump that may be driven, for example, by a diesel or hydraulic system. Hydraulic power may also be used to raise, lower, and rotate the frame.

A fuel injector and igniter may be disposed in the interior of the discharge pipe. By turning off the water flow and adding fuel to the jet exhaust stream at the injector, the system output becomes a large flame that can cover a distance of 300 feet or more, depending on the size of the jet engine. In this mode, a large area can be back burned in minutes after which the system can be switched back to water mode to put out the burn and create a large fire-break area.

The system may also be used as a large fog machine. Fire retardant may be mixed in a mixing tank, such as a portable truck-mounted mixing tank. By pumping the mixture into a holding tank coupled to the system, an additional supply of fire retardant can be provided. In the fogging mode, the ambient moisture in the fire area is raised, thus lowering the combustability of the air and fuel in the immediate area of interest. In the jet-blast mode the flames can be blown right back into the fire to stop or slow any advance at that point and push the fire back over itself to areas where the fuel has already been consumed.

### BRIEF DESCRIPTION OF THE DRAWING FIGURES

FIG. 1 is a diagram of an illustrative embodiment of a jet-blast firefighting system according to the present invention.

FIG. 2 is a diagram of an illustrative embodiment of vehicle carrier for a jet-blast firefighting system according to the present invention.

### DETAILED DESCRIPTION OF THE INVENTION

Those of ordinary skill in the art will realize that the following description of the present invention is illustrative only and not in any way limiting. Other embodiments of the invention will readily suggest themselves to such skilled persons.

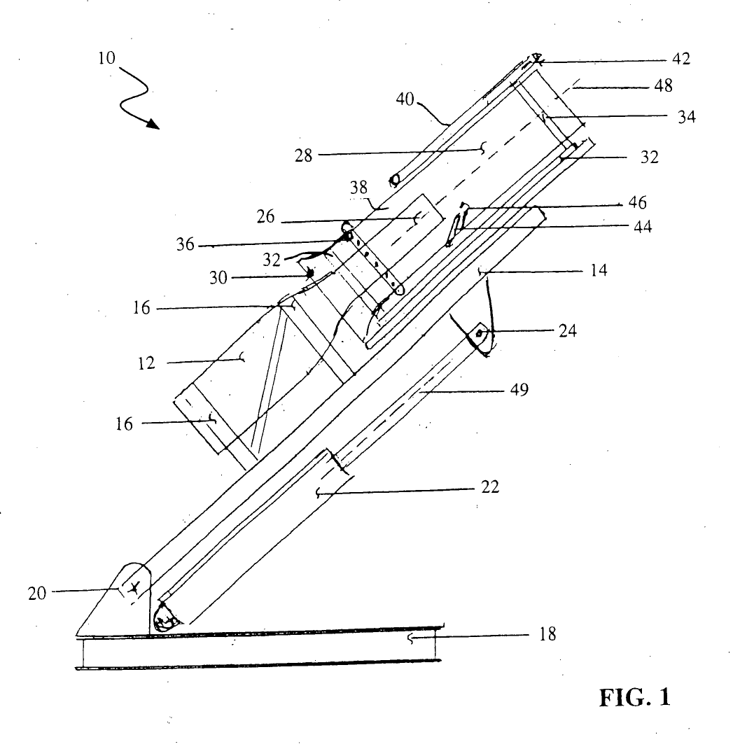

Referring first to FIG. 1, a diagram of an illustrative embodiment of a jet-engine-based multiple firefighting system 10 is shown. A jet engine 12 having a thrust of about 1,000 lbs. or more is mounted on a frame 14 using mounts shown at reference numerals 16. As will be appreciated by persons of ordinary skill in the art, the mounting should be adequate considering the thrust of jet engine 12. This is a matter of routine mechanical design considerations.

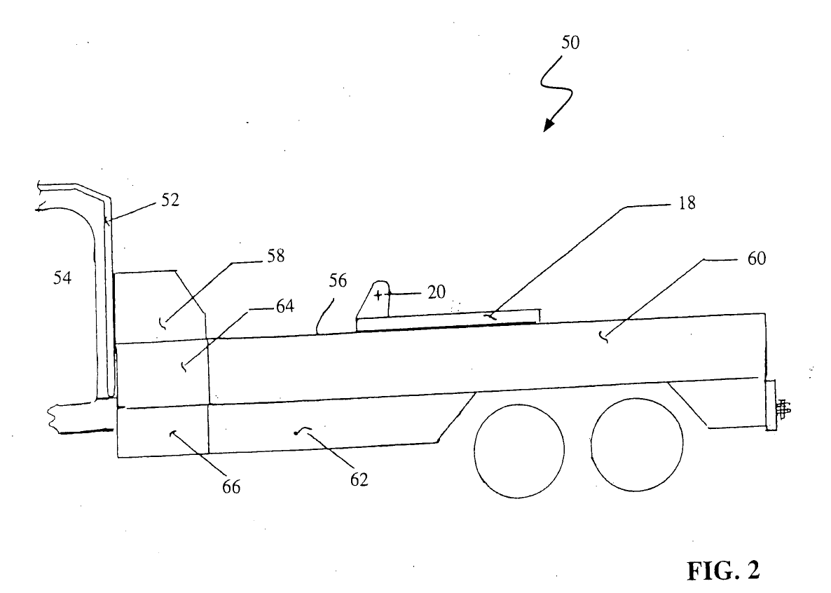

The frame 14 may be both pivotally and rotatably mounted on a platform 18 at pivot point 20, allowing for vertical and horizontal adjustment about pivot point 20. In this regard, a hydraulic ram 22 is shown coupled between platform 18 and a hydraulic-ram mount 24 disposed on frame 14. As will be shown with reference to FIG. 2, the platform 18 may be mounted on a truck, trailer, other track or 6×6 carrier to be mobile.

A tailpipe 26 is fitted to the exhaust end of the jet engine 12 and may be formed from a material such as tubular stainless steel. An outer discharge pipe 28 is disposed around and spaced apart from the tailpipe 26. Outer discharge pipe 28 may have a flared intake end 30 into which the tailpipe 26 extends. The outer discharge pipe 28 may be generally cylindrical in shape and formed from a material such as tubular steel. Outer discharge pipe 28 is mounted to a discharge pipe frame 32 using mounts 34. Discharge pipe frame 32 is slideably mounted on frame 14 and is translatable along an axis defined by the longitudinal axis 48 of tailpipe 26. Outer discharge pipe 28 may be translated using a variety of means including, but not limited to, hydraulic ram 22 moving along longitudinal axis 49, or an electric motor gear-drive, etc. (not shown).

A tubular injection ring 36 is mounted on the outer discharge pipe 28 at a location preferably outside of the tailpipe 26. Tubular injection ring 36 is provided with a plurality of inward facing apertures through which water or other firefighting liquid may be injected via a supply hose (not shown) into the annular space 38 between the tailpipe 26 and the outer discharge pipe 28. A delivery pipe 40 ending in a delivery nozzle 42 may be mounted on the outer discharge pipe 28 with the delivery nozzle 42 disposed near the exhaust end of the outer discharge pipe 28, through which water, gel, or soap may be delivered via a supply hose (not shown) mounted at the exhaust end of the discharge pipe 28.

During operation of the system 10, the jet blast travels from the jet-engine exhaust and through the tailpipe 26 and into the outer discharge pipe 28. The space 38 between the intake end of the outer discharge pipe 28 and the tailpipe 26 acts as a venturi that may be varied by translating the outer discharge pipe 28 along its axis to vary the amount of air pulled in through its flared intake end. Pressurized water is fed to the injection ring 36 and into the venturi, where it is atomized and travels along with the fast flow of heated jet exhaust.

The amount of water injected from the tubular injection ring 36 into the discharge pipe 28 may be varied from zero to about 500 gallons per minute, if needed, at pressures from between about zero to about 300 psi. With the jet engine 12 running at about 70% power and the water flow set at about 30 to about 50 gallons per minute at a pressure of about 150 psi, the discharge from outer discharge pipe 28 is like a heavy fog. If the water flow rate and pressure is increased, the system 10 acts as a very large fine-spray nozzle. If a foam concentrate is added to the water, the discharge comprises a fire-retardant foam that can totally engulf an average house and surrounding grounds within about one minute.

By pumping a fire-retardant mixture through the nozzle 42 at the exhaust end of the discharge pipe 28, the fire retardant mixture can be spread over a large area in seconds as the unit on which the system 10 is mounted moves along at a slow speed. At full jet-engine power, the system 10 can cover about two acres in a minute. The soap concentrate can be added into the water by means of an injection pump (not shown). The water pressure may be established and maintained by use of a high-pressure fire pump (not shown) that may be driven, for example, by a diesel or hydraulic system. Hydraulic power may also be used to raise, lower, and/or rotate the frame 14. Persons of ordinary skill in the art will appreciate that, if the frame 14 is to be rotated, some form of stabilization, such as outriggers, may be employed to prevent the jet action of the system 10 from turning the vehicle on which it is mounted on its side.

A fuel injector 44 and igniter 46 may be disposed in the interior of the discharge pipe. By turning off the water flow and adding fuel provided through a fuel supply hose (not shown) to the jet exhaust stream at the injector 44, the system output becomes a large flame that can cover a distance of 300 feet or more, depending on the size of the jet engine 12. In this mode, a large area can be back burned in minutes after which the system 12 can be switched back to water mode in order to put out the burn and create a large fire-break area.

The system may also be used as a large fog machine. Fire retardant may be mixed in a mixing tank, such as a portable truck-mounted mixing tank. By pumping the mixture into a holding tank coupled to the system, an additional supply of fire retardant can be provided. In the fogging mode, the ambient moisture in the fire area is raised, thus lowering the combustability of the air and fuel in the immediate area of interest. In the jet-blast mode the flames can be blown right back into the fire to stop or slow any advance at that point and push the fire back over itself to areas where the fuel has already been consumed.

Referring now to FIG. 2, an illustrative vehicular environment for the present invention is shown. Persons of ordinary skill in the art will appreciate that the configuration of the vehicle shown is merely suggestive and not limiting, and is presented for the purpose of disclosing only one possible configuration out of many for such a vehicle.

A vehicle 50 is shown having a cab shield 52 for protecting the cab 54. Platform 18 and pivot point 20 of the system 10 of FIG. 1 are shown mounted on vehicle bed 56. Platform 18 may be rotatable, if desired, although the rotational system, such as a hydraulic or electrically-driven system, is not explicitly shown in the figure.

Pumps for delivering water concentrate and fire retardant may be housed at a location such as shown at reference numeral 58. A water tank 60 may be mounted on the vehicle frame. One or more fuel tanks 62 and 64 may also be provided on vehicle 50. A sump 66 may be provided for water tank 60 and water pump suction. Although not shown in the figure, connections for hoses to supply water and or fire retardant from external tenders and mixers may also be provided.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A jet-engine based multiple firefighting system comprising:
a platform;
a frame pivotally mounted on said platform at a pivot point;
a jet engine mounted on said frame;
a tailpipe extending from an exhaust end of said jet engine;
an outer discharge pipe slideably mounted on said frame and disposed around said tailpipe to define an annular space, said outer discharge pipe having an intake end into which said tailpipe extends; and
a liquid injection system mounted on said outer discharge pipe around said tailpipe and configured to inject firefighting liquid into said annular space.

2. The system of claim 1, wherein said jet engine has a thrust of at least 1,000 lbs.

3. The system of claim 1, wherein said platform is mounted on a vehicle.

4. The system of claim 1, wherein said frame may pivot vertically about said pivot point.

5. The system of claim 4, wherein said frame may pivot horizontally about said pivot point.

6. The system of claim 1, wherein said liquid injection system comprises a tubular injection ring having a plurality of apertures directed into said annular space.

7. The system of claim 6, wherein said firefighting liquid comprises water.

8. The system of claim 7, further including a water delivery system fluidly coupled to said plurality of apertures of said tubular injection ring.

9. The system of claim 8, wherein said water delivery system can inject water into said annular space at a flow rate up to about 500 gallons per minute.

10. The system of claim 8, wherein said water delivery system can inject water into said annular space at a pressure up to about 300 psi.

11. The system of claim 1, wherein said tailpipe comprises a longitudinal axis and said outer discharge pipe is translatable along an axis defined by said longitudinal axis.

12. The system of claim 1, further comprising a fuel injector and an igniter disposed in the interior of said outer discharge pipe, said fuel injector coupled to a fuel source.

13. The system of claim 1, further comprising a fluid delivery nozzle coupled to a fluid source, said fluid delivery nozzle disposed at the exhaust end of said outer discharge pipe.

14. The system of claim 1, further comprising a hydraulic ram coupled between said platform and said frame.

15. A method for fighting fire comprising:
providing exhaust from a jet engine through a tailpipe encased within an outer discharge tube, said tailpipe having a longitudinal axis and mounted on a frame, said outer discharge tube being slideably mounted on said frame, said frame being pivotally mounted on a platform at a pivot point;
mixing a stream of water with said jet engine exhaust in said outer discharge tube to form a high-velocity firefighting mixture; and
directing said high-velocity firefighting mixture at a fire.

16. The method of claim 15, wherein said jet engine has a thrust of at least 1,000 lbs.

17. The method of claim 15, wherein a tubular injection ring having a plurality of inward facing apertures is mounted on said outer discharge tube, and said stream of water is injected into said outer discharge tube through said plurality of apertures.

18. The method of claim 15, wherein said outer discharge tube is translatable along an axis defined by said longitudinal axis of said tailpipe.

19. The method of claim 15, wherein said frame may pivot vertically about said pivot point.

20. The method of claim 19, wherein said frame may pivot horizontally about said pivot point.
